(19) United States
(12) Patent Application Publication
(10) Pub. No.: US 2018/0295389 A1
(43) Pub. Date: Oct. 11, 2018

(54) VIDEO DISTRIBUTION DEVICE, VIDEO DISTRIBUTION SYSTEM, AND METHOD OF DISTRIBUTING VIDEO

(71) Applicant: FUTURISM WORKS CORPORATION, Tokyo (JP)

(72) Inventor: Yasuhisa KAKURAI, Tokyo (JP)

(73) Assignee: FUTURISM WORKS CORPORATION

(21) Appl. No.: 15/944,976

(22) Filed: Apr. 4, 2018

(30) Foreign Application Priority Data
Apr. 6, 2017 (JP) 2017-075937

(51) Int. Cl. H04N 21/218; H04N 21/433; H04N 21/4223; H04N 21/81; H04N 21/4728

(52) U.S. Cl. CPC H04N 21/21805; H04N 21/4334; H04N 21/4728; H04N 21/812; H04N 21/8146; H04N 21/4223

(57) ABSTRACT

A video distribution device includes a reception unit that receives, from a first viewing device, as specified for each frame of a plurality of frames in a free viewpoint video, information related to a position and a direction of a virtual camera that is configured to observe the free viewpoint video that comprises each said frame; a recording unit that records, the information related to the position and the direction of the virtual camera received by the reception unit, together with each said frame of the free viewpoint video corresponding to the information related to the position and the direction of the virtual camera; and a transmission unit that transmits, to a second viewing device, a correspondence between the information and the frame of the free viewpoint video recorded by the recording unit for the information related to the position and the direction for the each frame.

### RELATED APPLICATIONS INFORMATION

This application is based upon and claims the benefit of priority from Japanese Patent Application No. 2017-075937, filed on Apr. 6, 2017, the disclosure of which is incorporated herein by reference in its entirety.

### BACKGROUND

### Field

The present invention relates to a video distribution device, a video distribution system, and a method of distributing video.

### Related Art

Recently, a related art technology known as “free viewpoint video” has been developed. Free viewpoint video allows a user to freely change his/her viewpoint for observing video, and has been expected to be applied to various video content.

For the related art free viewpoint video, for example, Patent Publication JP 2015-231114 A (the disclosure of which is incorporated herein by reference in its entirety) describes a video display device that determines which one of a viewing mode (e.g., viewing a display position of the free viewpoint video) and a transition mode (e.g., changing or moving of the viewpoint of the free viewpoint video) is established by the video display device. The video display device may change and display free viewpoint video between free viewpoint video corresponding to viewpoint information of transitioning viewpoints to free viewpoint video corresponding to viewpoint information of a display viewpoint position. In such implementations, in the transition mode, a plurality of virtual viewpoints on a line reaching the display viewpoint position may be set and free viewpoint video corresponding to the virtual viewpoints is successively switched and displayed. Further, in the viewing mode, free viewpoint video corresponding to the display viewpoint position is displayed.

### SUMMARY

Free viewpoint video allows its user to freely change his/her viewpoint for observing video so that he/she can enjoy viewing the video from a viewpoint determined according to his/her interest/preference. However, a user of free viewpoint video may not enjoy the benefit that he/she can change his/her viewpoint in viewing the video, if he/she is not accustomed to operating a viewpoint of free viewpoint video.

In view of the above circumstances, example embodiments described herein provide video distribution devices, video distribution systems, and methods of distributing video that allows a user to change his/her viewpoint even if he/she is not accustomed to operating a viewpoint of free viewpoint video.

According to an aspect of the present disclosure, a video distribution device is provided that includes a reception unit that receives, from a first viewing device, as specified for each frame of a plurality of frames in a free viewpoint video, information related to a position and a direction of a virtual camera that is configured to observe the free viewpoint video that comprises each said frame of the plurality of frames; a recording unit that records, the information related to the position and the direction of the virtual camera received by the reception unit, together with each said frame of the plurality of frames of the free viewpoint video corresponding to the information related to the position and the direction of the virtual camera; and a transmission unit that transmits, to a second viewing device, a correspondence between the information related to the position and the direction of the virtual camera and the frame of the free viewpoint video recorded by the recording unit for the information related to the position and the direction of for each said frame of the frames of the free viewpoint video.

In some example embodiments, according to the aspect, information related to a position and a direction of a virtual camera is received from the first viewing device used by a user relatively accustomed to operating a viewpoint of free viewpoint video and recorded together with the frame of free viewpoint video corresponding to such information, and the correspondence between the information related to the position and the direction of the virtual camera and the frame of the free viewpoint video is transmitted to the second viewing device. Thus, free viewpoint video obtained by a user relatively accustomed to operating a viewpoint may be reproduced by the second viewing device, which may be used by a user not necessarily accustomed to operating a viewpoint of free viewpoint video. Accordingly, even if a user is not necessarily accustomed to operating a viewpoint of free viewpoint video, he/she may be able to change a viewpoint.

In some example embodiments of the above aspect, the transmission unit may transmit, to the second viewing device, a list including a plurality of correspondences between information related to a plurality of positions and a plurality of directions of the virtual camera and the frame of the free viewpoint video, the reception unit may receive, from the second viewing device, a correspondence selected from among the plurality of correspondences, and the transmission unit may transmit the selected correspondence to the second viewing device.

According to the aspect, a desired viewpoint may be selected from among a plurality of viewpoints. Therefore, even if a user is not necessarily accustomed to operating a viewpoint of free viewpoint video, he/she may observe free viewpoint video with a plurality of viewpoints and may be able to change a viewpoint.

In some example embodiments of the above aspect, the video distribution device may further include: a first determination unit that determines a display position and a display direction of an advertisement based on the information related to the position and the direction of the virtual camera, and the transmission unit may transmit, to the second viewing device, information for displaying the advertisement at the display position and in the display direction determined by the first determination unit.

According to the aspect, a display position and a display direction of an advertisement may be changed according to a position and a direction of a virtual camera that observes free viewpoint video. Therefore, an advertisement display suitable for each viewpoint may be performed, and an advertisement effect may be improved.

In some example embodiments of the above aspect, the video distribution device may further include a second determination unit that determines display positions and display directions of a plurality of avatars based on information related to a plurality of positions and a plurality of directions of the virtual camera, and the transmission unit may transmit, to the second viewing device, information for displaying the plurality of avatars at the display positions and in the display directions determined by the second determination unit.

According to the aspect, avatars of other users observing the same viewpoint video are displayed according to a position and a direction of a virtual camera. Therefore, since users feel the existence of other users, the same video experience may be shared between the plurality of users.

In the above aspect, the reception unit may receive the information related to the position and the direction of the virtual camera, from the second viewing device.

According to the aspect, a viewpoint of edited free viewpoint video may be further changed according to a user's own interest. Therefore, even if a user is not necessarily accustomed to operating a viewpoint of free viewpoint video, he/she may enjoy having a new viewpoint based on edited free viewpoint video.

In the above aspect, the transmission unit may transmit information for restricting the position and the direction of the virtual camera, to the second viewing device.

According to the aspect, a change in a viewpoint of free viewpoint video is restricted in the second viewing device. Thus, even in a case in which it is desirable to partially restrict the observation of free viewpoint video, it is possible to distribute the free viewpoint video without changing the free viewpoint video itself.

In the above aspect, the reception unit may receive, from the first viewing device, information related to at least any of a movement direction, a movement speed, movement acceleration, a focal length, a field angle and a depth of a visual field of the virtual camera, and information related to a line of sight relative to a user of the first viewing device, and the recording unit may record, in correspondence with each other, the frame of the free viewpoint video, and the information, received by the reception unit, related to at least any of the movement direction, the movement speed, the movement acceleration, the focal length, the field angle and the depth of the visual field of the virtual camera, and the information related to the line of sight relative to the user of the first viewing device.

According to the aspect, by recording additional information including a movement direction, a movement speed, movement acceleration, a focal length, a field angle, and a depth of a visual field of a virtual camera, and information related to the line of sight in correspondence with a frame of free viewpoint video, a more impressive dynamic viewpoint may be shared with other users.

In the above aspect, the video distribution may further include a third determination unit that determines a position and a direction of another virtual camera so as to maintain a relationship (e.g., prescribed relationship) with the position and the direction of the virtual camera, and the transmission unit may transmit, to the second viewing device, a correspondence between information related to the position and the direction of the other virtual camera determined by the third determination unit, and the frame of the free viewpoint video.

According to the aspect, a position and a direction of another virtual camera corresponding to another user are determined based on a position and a direction of a virtual camera corresponding to a user. Thus, since viewpoints of a plurality of users may be linked to each other, the plurality of users is allowed to share the same video experience.

In the above aspect, the recording unit may record a range imaged by the virtual camera and the frame of the free viewpoint video in correspondence with each other.

According to the aspect, the video distribution device may distribute a range of free viewpoint video imaged by a virtual camera to a first viewing device, and may not distribute a range of the free viewpoint video not imaged by the virtual camera to the first viewing device or may distribute the same by lowering the resolution of the range of the free viewpoint video. Thus, a calculation load or a communication load for distributing free viewpoint video may be reduced.

According to another aspect of the present disclosure, a video distribution system is provided, the video distribution system includes: a first viewing device that specifies a position and a direction of a virtual camera that observes free viewpoint video in correspondence with a frame of the free viewpoint video; and a second viewing device that reproduces the free viewpoint video based on the correspondence between the position and the direction of the virtual camera specified by the first viewing device, and the frame of the free viewpoint video.

In some example embodiments, according to the aspect, a second viewing device may receive a correspondence between information related to a position and a direction of a virtual camera and a frame of free viewpoint video, from a first viewing device used by a user relatively accustomed to operating a viewpoint of free viewpoint video via a video distribution device or may directly receive the same from the first viewing device by, for example but not by way of limitation, P2P. However, other protocols for receiving information from the first viewing device are possible. Therefore, even the second viewing device used by a user not necessarily accustomed to operating a viewpoint of free viewpoint video may be able to change a viewpoint.

According to another aspect of the present disclosure, a method of distributing video is provided, the method includes: transmitting, to the second viewing device, a list including a plurality of correspondences between information related to a plurality of positions and a plurality of directions of the virtual camera and the each frame of the free viewpoint video; receiving, from the second viewing device, a correspondence selected from among the plurality of correspondences; and transmitting the selected correspondence to the second viewing device.

In some example embodiments, according to the aspect, a second viewing device may receive a correspondence between information related to a position and a direction of a virtual camera and a frame of free viewpoint video, from a first viewing device used by a user relatively accustomed to operating a viewpoint of free viewpoint video via a video distribution device or may directly receive the same from the first viewing device by, for example, P2P. However, other protocols for receiving information from the first viewing device are possible. Therefore, even the second viewing device used by a user not necessarily accustomed to operating a viewpoint of free viewpoint video may be able to change a viewpoint.

According to an aspect of the present disclosure, it is possible to provide a video distribution device, a video distribution system, and a method of distributing video that may allow a user to be able to change a viewpoint even if he/she is not necessarily accustomed to operating a viewpoint of free viewpoint video.

### BRIEF DESCRIPTION OF DRAWINGS

FIG. 1 is a configuration diagram of a video distribution system according to an example embodiment;

FIG. 2 is a function block diagram of a video distribution device according to an example embodiment;

FIG. 3 is a conceptual diagram showing a position and a direction of a virtual camera according to the example embodiment;

FIG. 4 is a diagram showing a display example of video displayed on a viewing device according to the example embodiment;

FIG. 5 is a flowchart of first processing performed by the video distribution system according to an example embodiment;

FIG. 6 is a flowchart of second processing performed by the video distribution system according to an example embodiment;

FIG. 7 is a flowchart of third processing performed by the video distribution system according to an example embodiment;

FIG. 8 is a flowchart of fourth processing performed by the video distribution system according to an example embodiment; and

FIG. 9 is a flowchart of fifth processing performed by the video distribution system according to an example embodiment.

### DETAILED DESCRIPTION

Hereinafter, example embodiments of the present disclosure will be described with reference to the attached drawings. The following explanation illustrates one example or more example embodiments, but the present inventive concept shall not be limited to the following example embodiment. Constituents denoted by the same symbols have the same or similar configurations in respective figures.

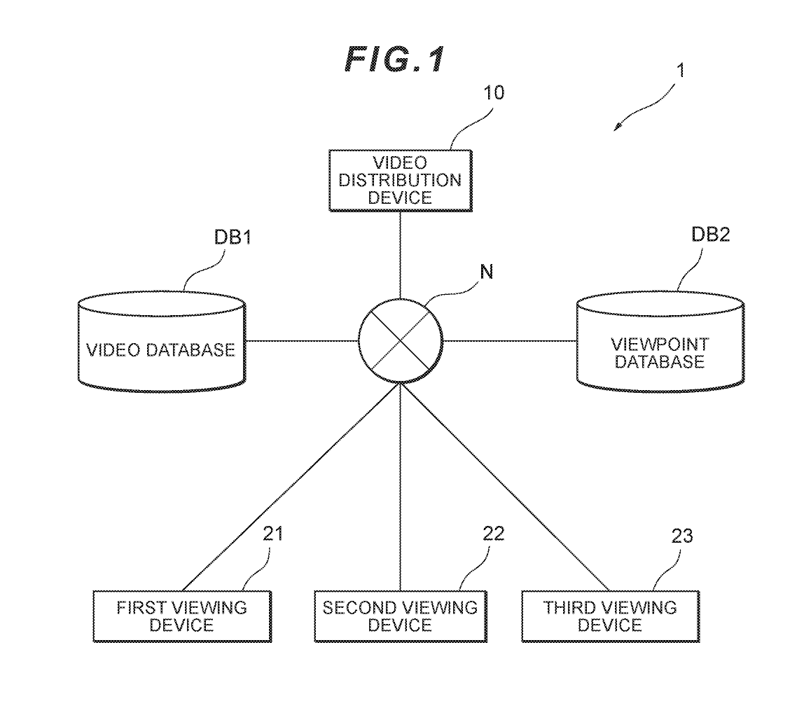

FIG. 1 is a configuration diagram of a video distribution system 1 according to an example embodiment. The video distribution system 1 has a video distribution device 10, a first viewing device 21, a second viewing device 22, a third viewing device 23, a video database DB1, and a viewpoint database DB2. The video distribution device 10, the first viewing device 21, the second viewing device 22, the third viewing device 23, the video database DB1, and the viewpoint database DB2 are connected (e.g., communicatively coupled) to each other via a communication network N. The communication network N may be the Internet and represents a network based on wired communication or wireless communication. The communication network N may be a local area network (LAN) or any other network. Further, the first through third viewing devices 21-23 may be, for example, video viewing devices.

The video distribution system 1 distributes free viewpoint video stored in the video database DB1 to the first viewing device 21, the second viewing device 22, and the third viewing device 23. The video distribution system 1 may receive information of a viewpoint of free viewpoint video from at least one or more of the first viewing device 21, the second viewing device 22, and the third viewing device 23 and may record the same on the viewpoint database DB2. Free viewpoint video in the present specification represents video whose viewpoint may be freely changed. Free viewpoint video may be reproduced by a dedicated or general-purpose viewing device, and is distributed in real time (broadcasted live) or recorded in advance to be distributed on demand.

Each of the first viewing device 21, the second viewing device 22, and the third viewing device 23 is a device capable of reproducing free viewpoint video, and may be used by a user relatively accustomed to editing free viewpoint video or a user not necessarily accustomed to editing free viewpoint video. Each of the first viewing device 21, the second viewing device 22, and the third viewing device 23 may be configured when a dedicated application is installed on general-purpose equipment such as, for example, a personal computer and a smartphone. As used herein, the first viewing device 21 may correspond to a “first viewing device” and that the second viewing device 22 may correspond to a “second viewing device.” However, any of the first viewing device 21, the second viewing device 22, and the third viewing device 23 may correspond to either a “first viewing device” and/or a “second viewing device.” Also, in the present disclosure, description is made assuming that the three viewing devices are connected to the video distribution device 10. However, the number of viewing devices connected to the video distribution device 10 may be more or less than three, and viewing devices may be connected to each other by, for example, peer to peer (P2P) or other communication protocols that would be understood by those skilled in the art.

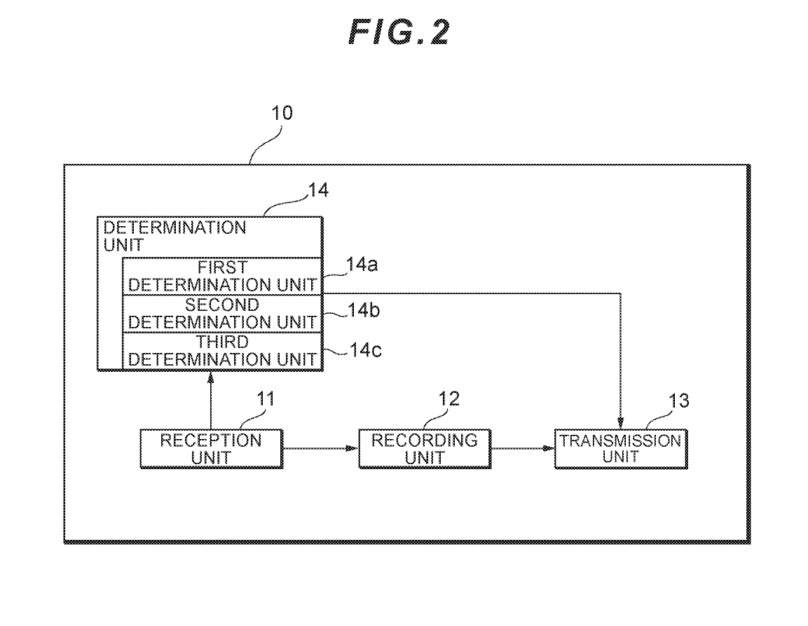

FIG. 2 is a function block diagram of the video distribution device 10 according to at least one example embodiment. The video distribution device 10, for example, of FIG. 1, has a reception unit 11, a recording unit 12, a transmission unit 13, and a determination unit 14. For example but not by way of limitation, the reception unit 11 may be a receiving device, the recording unit 12 may be a recording device, and the transmitting unit 13 may be a transmitting device. The determination unit 14 may be a processor or microprocessor configured to perform logic operations.

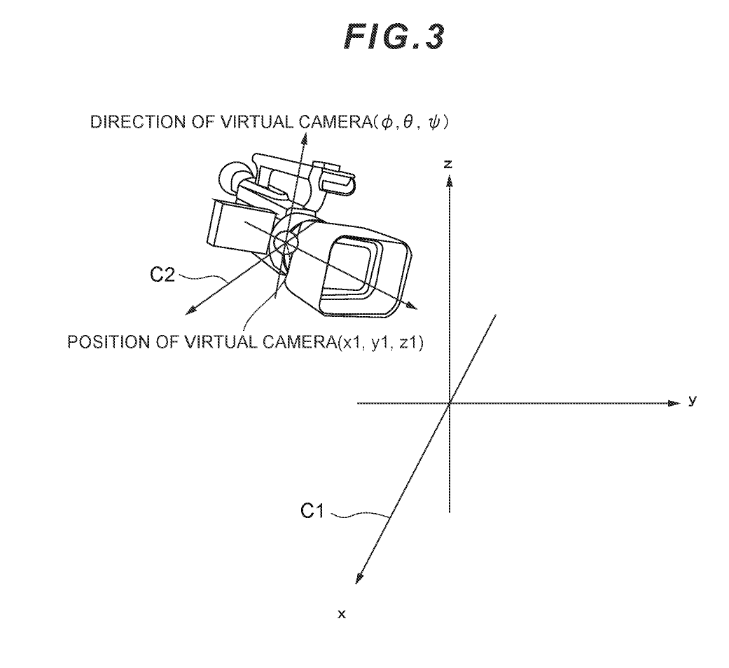

The reception unit 11 receives, from a first viewing device, information related to a position and a direction of a virtual camera that may observe free viewpoint video. For example, the reception unit 11 receives information related to a position and a direction of a virtual camera from the first viewing device 21. The recording unit 12 records, in correspondence with each other, information about a position and a direction of a virtual camera received by the reception unit 11, and a frame of free viewpoint video. Here, a frame of free viewpoint video may represent a still image constituting the free viewpoint video. A frame of free viewpoint video may be identified by, for example, an ID attached to the frame or a time stamp attached to the frame. The recording unit 12 records a correspondence between a frame of free viewpoint video stored in the video database DB1 and information related to a position and a direction of a virtual camera received by the reception unit 11 on the viewpoint database DB2. Here, a correspondence between information related to a position and a direction of a virtual camera and a frame of free viewpoint video may be performed by making position coordinates and direction coordinates of the virtual camera and an ID attached to the frame of the free viewpoint video correspond to each other. In another example embodiment, alone or in combination, correspondence may be performed by making the position coordinates and the direction coordinates of the virtual camera and a time stamp attached to the frame of the free viewpoint video correspond to each other, or may be performed by any other method. For example, when information related to a position and a direction of a virtual camera and a time stamp attached to a frame of free viewpoint video are made to correspond to each other, a plurality of frames may become corresponding candidates. Even in this example, it is possible to appropriately determine the correspondence based on the time stamp. Position coordinates and direction coordinates of a virtual camera will be described in detail with reference to FIG. 3.

The transmission unit 13 transmits, to a second viewing device, the correspondence between information related to a position and a direction of a virtual camera and a frame of free viewpoint video recorded by the recording unit 12. For example, the transmission unit 13 transmits, to the second viewing device 22, a correspondence between information related to a position and a direction of a virtual camera and a frame of free viewpoint video.

If the user of the first viewing device 21 is relatively accustomed to operating a viewpoint of free viewpoint video and the user of the second viewing device 22 is not necessarily accustomed to operating a viewpoint of free viewpoint video, information related to a position and a direction of a virtual camera can be received from the first viewing device 21 used by the user relatively accustomed to operating a viewpoint of free viewpoint video and recorded in correspondence with a frame of free viewpoint video, and a correspondence between the position and the direction of the virtual camera and the frame of the free viewpoint video can then be transmitted to a second viewing device 22. Thus, a free viewpoint video obtained by a user relatively accustomed to operating a viewpoint may be reproduced by the second viewing device 22 used by a user relatively not necessarily accustomed to operating a viewpoint of free viewpoint video. Accordingly, even if a user is not necessarily accustomed to operating a viewpoint of free viewpoint video, he/she may be able to change a viewpoint.

Further, the transmission unit 13 may transmit, to the second viewing device 22, a list including a plurality of correspondences between information related to a plurality of positions and a plurality of directions of a virtual camera and a frame of free viewpoint video. The list may include video (e.g., as thumbnail videos) so that the plurality of correspondences between the plurality of positions and directions of the virtual camera and the frame of the free viewpoint video may be easily understandable. The reception unit 11 receives a correspondence selected from among a plurality of correspondences from the second viewing device 22, and the transmission unit 13 transmits the selected correspondence to the second viewing device 22.

Further, the reception unit 11 may receive information related to a position and a direction of a virtual camera from the second viewing device 22. The reception unit 11 can receive information related to a position and a direction of a virtual camera not only from the first viewing device 21, but also or separately from the second viewing device 22. The reception unit 11 may receive information related to a position and a direction of a virtual camera from any viewing device.

Further, the transmission unit 13 may transmit information for restricting or constraining a position and a direction of a virtual camera to the second viewing device 22. For example, information for restricting a position and a direction of a virtual camera may represent information for restricting a change in a viewpoint of free viewpoint video in a viewing device, e.g., information including the settings of a region in which entering is prohibited with respect to a position and a direction of a virtual camera. By the transmission of information for restricting a position and a direction of a virtual camera to the second viewing device 22, a change in a viewpoint of free viewpoint video can be restricted in the second viewing device 22. Thus, even in a case in which it is desirable to partially restrict the observation of free viewpoint video, it is possible to distribute the free viewpoint video without changing the free viewpoint video.

Further, the reception unit 11 may receive information related to at least any one or more of a movement direction of a virtual camera, a movement speed of a virtual camera, movement acceleration of a virtual camera, and information about the line of sight measured relative to the user of the first viewing device 21 from the first viewing device 21. In some example embodiments, information related to the line of sight measured relative to the user of the first viewing device 21 can include information about the line of sight of the user of the first viewing device 21 measured by an eye tracker and information about a focal point, e.g., a point that the eye of the user is focusing upon. The recording unit 12 may record and store, on the viewpoint database DB2 and in correspondence with each other, a frame of free viewpoint video and the information, received by the reception unit 11, on at least any of the movement direction of a virtual camera, the movement speed of a virtual camera, the movement acceleration of the virtual camera, and the information related the line of sight measured relative to the user of the first viewing device 21. By recording additional information including a movement direction of a virtual camera, a movement speed of a virtual camera, movement acceleration of a virtual camera, and information related to the line of sight in correspondence with a frame of free viewpoint video, a more impressive dynamic viewpoint may be shared with other users.

The determination unit 14 may include a first determination unit 14a, a second determination unit 14b, and a third determination unit 14c. The first determination unit 14a can determine a display position and a display direction of an advertisement based on information about a position and a direction of a virtual camera. Here, an advertisement may include one or more of text information, image information, or a moving image. The first determination unit 14a may determine a display position and a display direction of an advertisement so that the advertisement can be easily viewed and viewing of free viewpoint video is not disturbed. The transmission unit 13 may transmit information for displaying an advertisement at a display position and in a display direction determined by the first determination unit 14a to the second viewing device 22.

The second determination unit 14b may determine display positions and display directions of a plurality of avatars based on information related to a plurality of positions and a plurality of directions of a virtual camera. Here, avatars may be one or more characters each representing a user. Avatars may include images, texts, or moving images and may be those registered by the users of viewing devices. The second determination unit 14b may determine display positions and display directions of each avatar according to positions and directions of a virtual camera corresponding to respective users. The transmission unit 13 may then transmit information for displaying a plurality of avatars at display positions and in display directions determined by the second determination unit 14b to the second viewing device 22.

The third determination unit 14c may determine a position and a direction of another virtual camera so as to maintain a prescribed relationship with a position and a direction of a virtual camera. Here, a position and a direction of another virtual camera are, for example, a position and a direction of a virtual camera corresponding to the third viewing device 23. The transmission unit 13 may transmit, to the second viewing device 22, a correspondence between information related to a position and a direction of another virtual camera determined by the third determination unit 14c and a frame of free viewpoint video.

FIG. 3 is a conceptual diagram showing a position and a direction of a virtual camera. In FIG. 3, world coordinates C1 of free viewpoint video and camera coordinates C2 following the virtual camera are shown. The world coordinates C1 are coordinates that may be fixed independent of a viewpoint for observing free viewpoint video, and represented by orthogonal coordinates of three axes (x, y, z) in the example of FIG. 3. The origin of the world coordinates C1 may be set at a position serving as the reference of free viewpoint video. For example, when free viewpoint video is about a soccer game, the origin of the world coordinates C1 may be set at the center of a field.

The origin of the camera coordinates C2 may be set at the center of the virtual camera, and the camera coordinates C2 may be coordinates to be inclined together along with the virtual camera. The origin of the camera coordinates C2 may be positioned at, for example, (x1, y1, z1) in the world coordinates C1. (x1, y1, z1) may represent the central position of the virtual camera in the world coordinates C1. Further, the camera coordinates C2 may be inclined together with the virtual camera, and the inclination can be represented by direction coordinates, for example, Euler angle coordinates (φ, θ, ψ). The direction coordinates (φ, θ, ψ) may represent a direction of inclination or rotation of the virtual camera. The origin of the direction coordinates (in the direction where φ=0, θ=0, and ψ=0) may be set in a direction corresponding to the coordinate axis of the world coordinates C1. Thus, a position of a virtual camera is specified by three-dimensional position coordinates, and a direction of the virtual camera is specified by three-dimensional direction coordinates.

Information related to a position and a direction of a virtual camera may include information other than position coordinates and direction coordinates of the virtual camera. For example, information related to a position and a direction of a virtual camera may include information for specifying a video projection surface and an image projected onto the projection surface. In this case, besides position coordinates and direction coordinates of the virtual camera, a focal length and a field angle (a horizontal field angle, a vertical field angle, and a diagonal field angle) of the virtual camera may be specified. Further, information related to a position and a direction of a virtual camera may include information about a depth of a visual volume. In this case, a depth of a visual field is specified.

The recording unit 12 of the video distribution device 10 may record a range imaged by a virtual camera and a frame of free viewpoint video in correspondence with each other. The video distribution device 10 may calculate a range imaged by a virtual camera based on at least one or more of any of a position, a movement direction, a movement speed, transfer acceleration, a focal length, a field angle, and a depth of a visual field of the virtual camera. A range imaged by a virtual camera may be a three-dimensional range or a two-dimensional range. The video distribution device 10 may distribute a range of free viewpoint video imaged by a virtual camera to a viewing device, and may not distribute a range of the free viewpoint video not imaged by the virtual camera to the viewing device or may distribute the same by lowering the resolution of the range of the free viewpoint video. Thus, capacity of free viewpoint video to be distributed may be reduced, and a calculation load or a communication load for distributing free viewpoint video may be reduced.

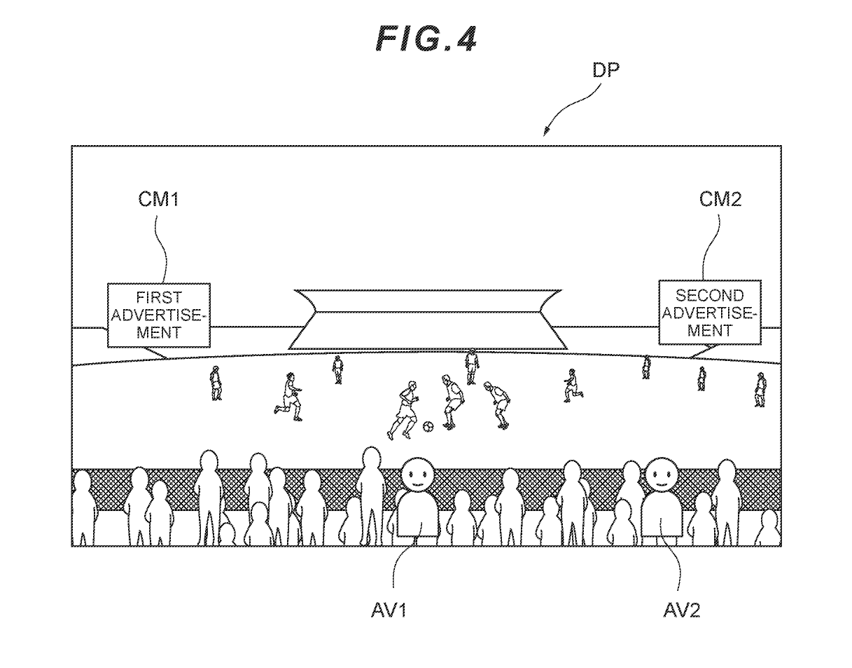

FIG. 4 is a diagram showing a display example DP of video displayed on a viewing device. The display example DP shown in FIG. 4 is an example of free viewpoint video displayed on any one or more of the first viewing device 21, the second viewing device 22, and the third viewing device 23.

The display example DP shows an example of free viewpoint video of a soccer game and includes a first advertisement CM1, a second advertisement CM2, a first avatar AV1, and a second avatar AV2. The first advertisement CM1 and the second advertisement CM2 are displayed at positions and in directions determined by the first determination unit 14a and displayed at locations at which the first advertisement CM1 and the second advertisement CM2 may be easily identified by users, without disturbing the observation of the soccer game by the users. The first avatar AV1 and the second avatar AV2 are avatars corresponding to other users viewing the same free viewpoint video. As illustrated in FIG. 4, it may be confirmed that two users are viewing the same free viewpoint video. When a viewpoint of the free viewpoint video is changed, display positions and display directions of the first advertisement CM1, the second advertisement CM2, the first avatar AV1, and the second avatar AV2 may be changed according to the movement of the viewpoint.

As described above, in the video distribution device 10 according to various example embodiments, a display position and a display direction of an advertisement may be changed according to a position and a direction of a virtual camera that observes free viewpoint video. Therefore, an advertisement display suitable for each viewpoint may be performed, and an advertisement effect may be improved. Further, avatars of other users observing the same free viewpoint video may be displayed according to a position and a direction of a virtual camera. Therefore, since a user may experience the existence of other users via respective avatars, the same video experience may be shared between the plurality of users.

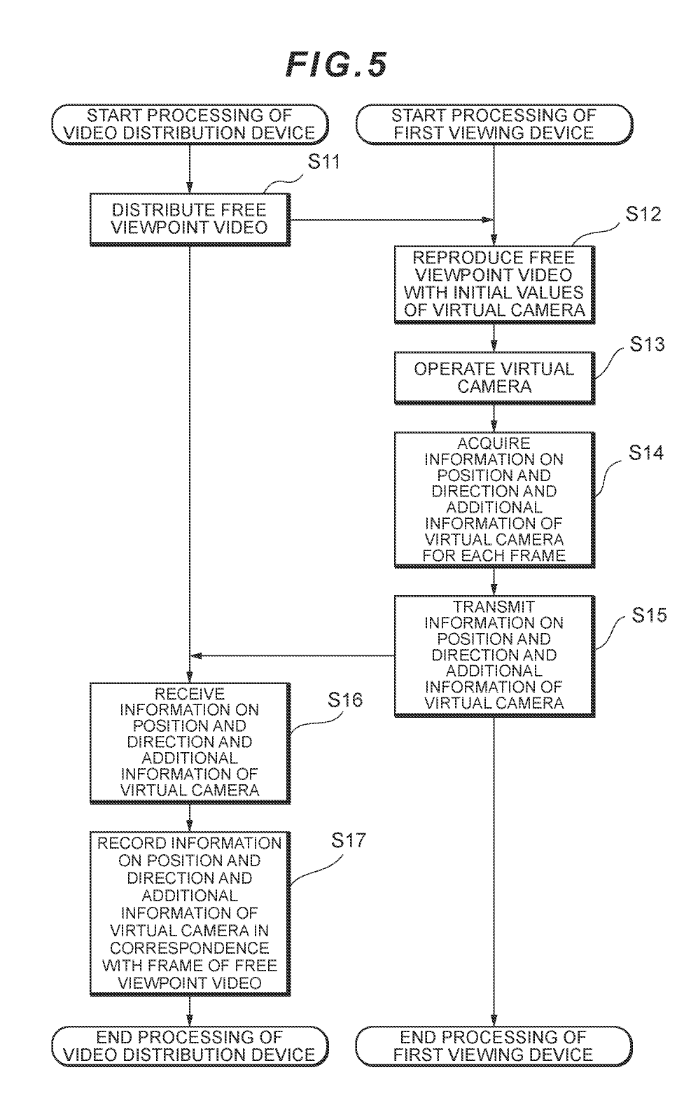

FIG. 5 is a flowchart of first processing performed by the video distribution system 1 according to at least one example embodiment. The first processing of FIG. 5 is processing in which the first viewing device 21 edits a viewpoint of free viewpoint video and then the video distribution device 10 registers the viewpoint.

First, the video distribution device 10 distributes free viewpoint video to the first viewing device 21 (S11). In some example embodiments, free viewpoint video may be distributed in real time, or free viewpoint video may have been recorded in the past and may be distributed at S11. The first viewing device 21 may reproduce the distributed free viewpoint video with initial values on a position and a direction of a virtual camera (S12).

A user may operate the virtual camera with the first viewing device 21 (S13). For example, the first viewing device 21 may receive, via the user operating the virtual camera, a change in a position, a direction, a movement direction, a movement speed, movement acceleration, a focal length, a field angle, and a depth of a visual field of the virtual camera from the user. Further, the first viewing device 21 may measure information related to the line of sight of the user viewing the free viewpoint video.

The first viewing device 21 acquires, for each frame of the free viewpoint video, information related to a position and a direction of the virtual camera and additional information including a movement direction, a movement speed, movement acceleration, a focal length, a field angle, and a depth of a visual field of the virtual camera and information related to the line of sight of the user (S14). In some example embodiments, the acquisition of the respective information performed for each frame may be repeatedly performed for each ID attached to the frame or may be repeatedly performed for each time stamp attached to the frame. Then, the first viewing device 21 transmits, for each frame of the free viewpoint video, information related to a position and a direction of the virtual camera and additional information to the video distribution device 10 (S15). Information related to a focal length, a field angle, and a depth of a visual field of the virtual camera may be included in additional information or may be included in information related to a position and a direction of the virtual camera. Further, the first viewing device 21 may determine whether the virtual camera has been operated, and may transmit information related to a position and a direction of the virtual camera and additional information to the video distribution device 10 only when the virtual camera has been operated.

When free viewpoint video is distributed in real time, the first viewing device 21 may sequentially transmit information related to a position and a direction of the virtual camera operated by the user and additional information to the video distribution device 10. Further, when free viewpoint video that was recorded in the past is distributed, the first viewing device 21 may collectively transmit information related to a position and a direction of the virtual camera operated by the user and additional information to the video distribution device 10.

The video distribution device 10 receives the information related to the position and the direction of the virtual camera and the additional information from the first viewing device 21 (S16). Then, the video distribution device 10 records a correspondence between the received information related to the position and the direction of the virtual camera and the additional information and the frame of the free viewpoint video on the viewpoint database DB2 (S17). In the manner described above, the first processing ends. Thus, for example, viewpoints of free viewpoint video edited by various users may be collected in the viewpoint database DB2. By analyzing collected viewpoints, viewpoints preferred by many users may be extracted and may be recommended to one or more users. Further, in addition to free viewpoint video, a viewpoint for observing the free viewpoint video may be distributed for a charge or for free.

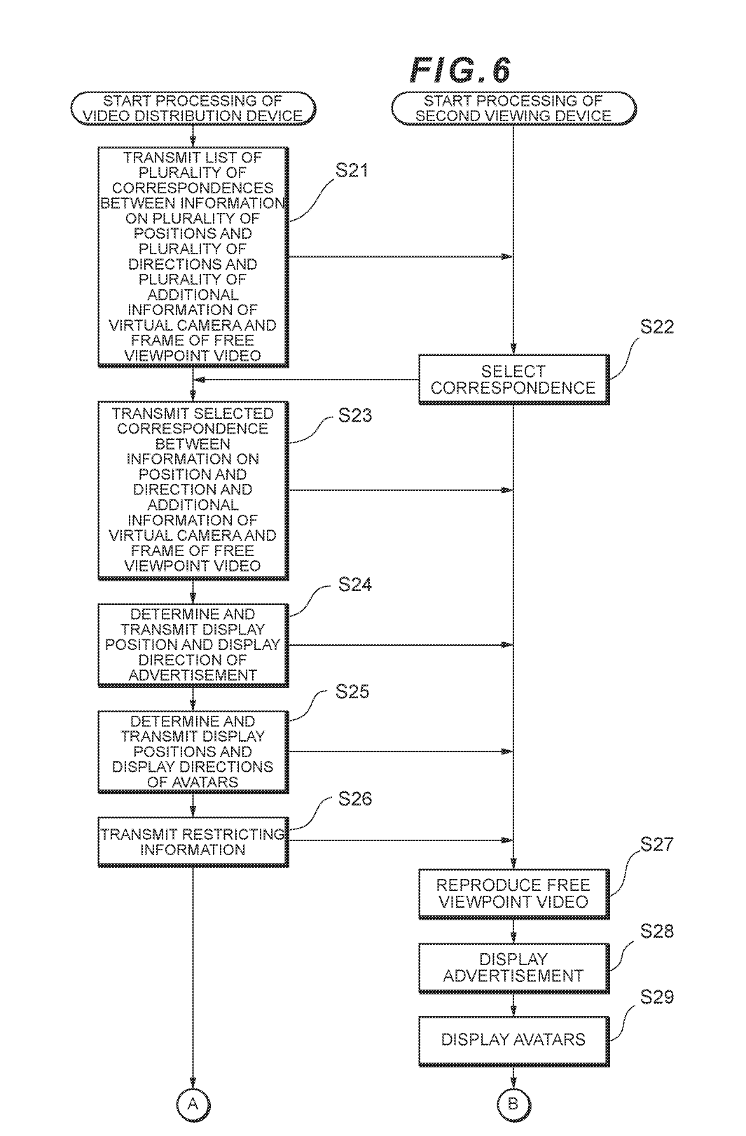

FIG. 6 is a flowchart of second processing performed by the video distribution system 1 according to at least one example embodiment. The second processing of FIG. 6 is processing in which the second viewing device 22 selects a viewpoint from among a list of the viewpoints of free viewpoint video and the video distribution device 10 distributes the free viewpoint video with the selected viewpoint.

First, the video distribution device 10 transmits, to the second viewing device 22, a list of correspondences between information about a plurality of positions and a plurality of directions and a plurality of additional information of a virtual camera and a frame of free viewpoint video (S21). The user of the second viewing device 22 selects, from the list, one of the correspondences between the information about the position and the direction and the additional information of the virtual camera and the frame of the free viewpoint video (S22).

The video distribution device 10 transmits, to the second viewing device 22, the selected correspondence between the information about the position and the direction and the additional information of the virtual camera and the frame of the free viewpoint video (S23). As described above, the user of the second viewing device 22 may select a desired viewpoint from a plurality of viewpoints. Therefore, even if the user is not necessarily accustomed to operating a viewpoint of free viewpoint video, he/she may observe free viewpoint video from a plurality of viewpoints and be able to change a viewpoint. When free viewpoint video is distributed in real time, the video distribution device 10 may sequentially transmit information about a position and a direction and additional information of a selected virtual camera to the second viewing device 22. Further, when free viewpoint video that was recorded in the past is distributed, the video distribution device 10 may collectively transmit information about a position and a direction and additional information of a selected virtual camera to the second viewing device 22.

The video distribution device 10 may determine a display position and a display direction of an advertisement based on the information about the position and the direction and the additional information of the virtual camera (S24). The video distribution device 10 may also transmit information for displaying the advertisement at the determined display position and in the display direction to the second viewing device 22 (S24).

Further, the video distribution device 10 determines display positions and display directions of a plurality of avatars based on information about a plurality of positions and a plurality of directions and a plurality of additional information of the virtual camera (S25). The video distribution device 10 may also transmit information for displaying the plurality of avatars at the determined display positions and in the display directions to the second viewing device 22 (S25).

Further, the video distribution device 10 may be able to transmit information for restricting a position and a direction of the virtual camera to the second viewing device 22 (S26).

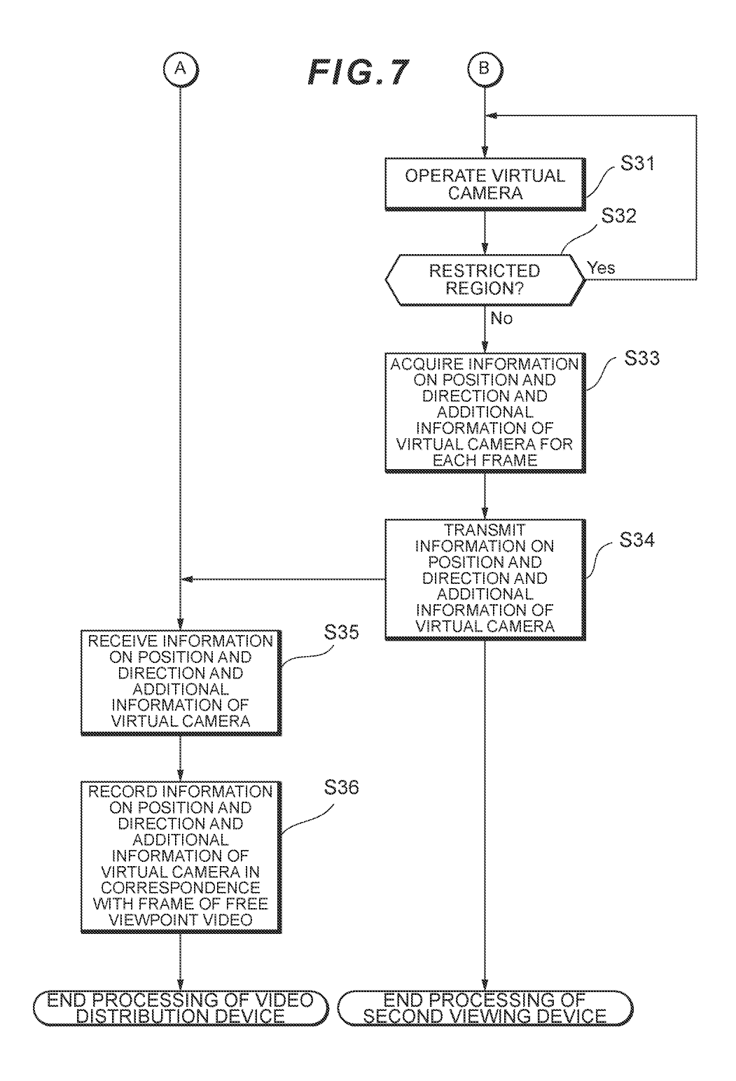

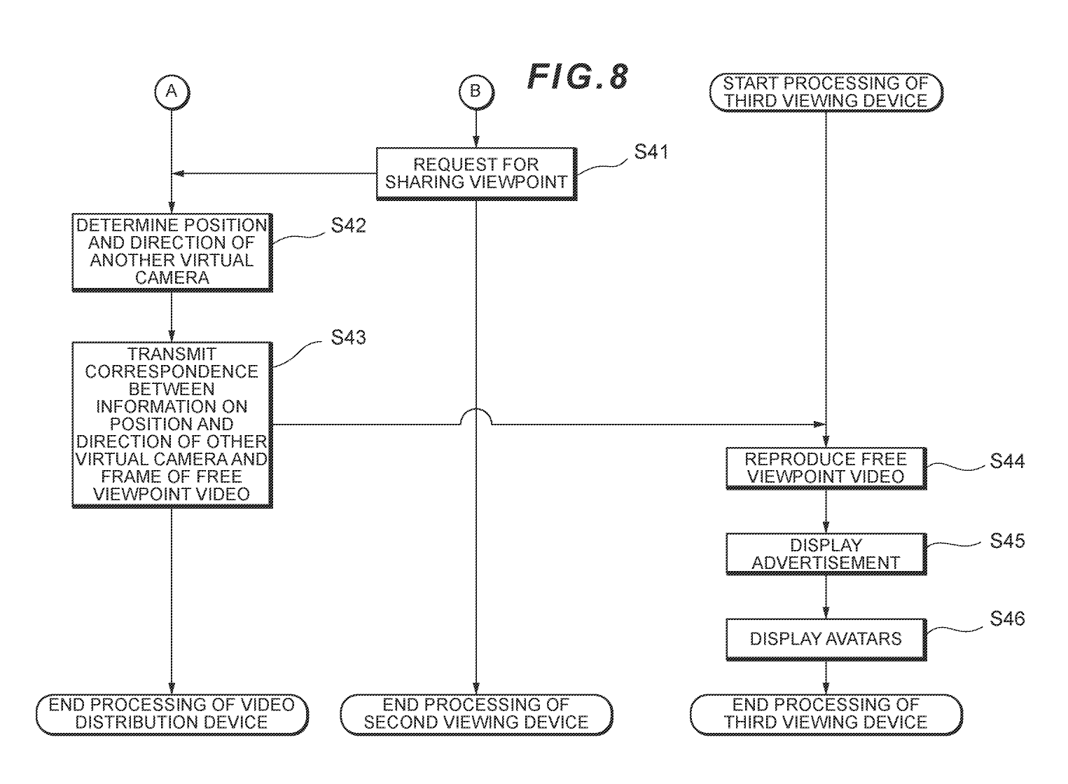

The second viewing device 22 reproduces the free viewpoint video based on the received correspondence between the information about the position and the direction and the additional information of the virtual camera and the frame of the free viewpoint video (S27). Further, the second viewing device 22 displays the advertisement at the display position and in the display direction determined by the video distribution device 10 (S28). Further, the second viewing device 22 displays the plurality of avatars at the display positions and in the display directions determined by the video distribution device 10 (S29). In the manner described above, the second processing ends. Third processing and fourth processing may be performed after the second processing and as will be described below with reference to FIGS. 7 and 8, respectively.

FIG. 7 is a flowchart of third processing performed by the video distribution system 1 according to at least one example embodiment. The third processing of FIG. 7 is processing in which the second viewing device 22 edits a viewpoint of free viewpoint video after the second processing and then the video distribution device 10 registers the viewpoint. In FIG. 7, “A” represents that the processing performed by the video distribution device 10 continues from the “A” of the second processing in FIG. 6. Similarly, “B” of FIG. 7 represents that the processing performed by the second viewing device 22 continues from “B” of the second processing in FIG. 6. However, in some example embodiments, the third processing may be performed separately from the second processing.

The user operates a virtual camera by changing a position, a direction, or the like of the virtual camera about the reproduced free viewpoint video with the second viewing device 22 (S31). The second viewing device 22 determines whether the requested position and the direction of the virtual camera fall within a restricted region specified by information for restricting the position and the direction of the virtual camera received from the video distribution device 10 (S32). When the requested position and/or the direction of the virtual camera fall within the restricted region (S32: Yes), the second viewing device 22 receives another operation of the virtual camera without reflecting the operation of the position and the direction (e.g., as operated in S31) of the virtual camera. On the other hand, when the requested position and the direction of the virtual camera do not fall within the restricted region (S32: No), the second viewing device 22 reflects the operation of the position and the direction of the virtual camera and acquires information about the position and the direction and additional information of the virtual camera (S33). After that, the second viewing device 22 transmits the information about the position and the direction and the additional information of the virtual camera to the video distribution device 10 (S34).

The video distribution device 10 receives the information about the position and the direction and the additional information of the virtual camera edited by the second viewing device 22 (S35). Then, the video distribution device 10 records a correspondence between the information about the position and the direction and the additional information of the virtual camera and a frame of the free viewpoint video on the viewpoint database DB2 (S36). In the manner described above, the third processing ends.

In the video distribution system 1 according to the example embodiment, a viewpoint of edited free viewpoint video may be further changed according to a user's own interest. Therefore, even if a user is not necessarily accustomed to operating a viewpoint of free viewpoint video, he/she may be able to have a new viewpoint based on edited free viewpoint video.

FIG. 8 is a flowchart of fourth processing performed by the video distribution system 1 according to at least one example embodiment. The fourth processing of FIG. 8 is processing in which a viewpoint for observing free viewpoint video is shared between the second viewing device 22 and the third viewing device 23. In FIG. 8, “A” represents that the processing performed by the video distribution device 10 continues from “A” of the second processing of FIG. 6. Similarly, “B” represents that the processing performed by the second viewing device 22 continues from the “B” of the second processing. However, in some example embodiments, the fourth processing may be performed separately from the second processing.

When the video distribution device 10 is requested by the second viewing device 22 to share a viewpoint (S41), the video distribution device 10 determines a position and a direction of another virtual camera so as to maintain a prescribed relationship with the position and the direction of the virtual camera (S42). In some example embodiments, the prescribed relationship may represent a relationship in which the virtual camera and the other virtual camera are set to observe the same point on the world coordinates C1 while maintaining a constant distance therebetween. Then, the video distribution device 10 transmits a correspondence between information about the position and the direction of the other virtual camera and a frame of the free viewpoint video to the third viewing device 23 (S43).

The third viewing device 23 reproduces the free viewpoint video based on the correspondence between the information about the position and the direction of the other virtual camera and the frame of the free viewpoint video (S44). Further, the third viewing device 23 displays an advertisement based on information of a display position and a display direction of the advertisement transmitted from the video distribution device 10 (S45). Avatars may then be displayed based on the information about display positions and display directions of each of the avatars transmitted from the video distribution device 10 (S46). In some example embodiments, the avatars include at least an avatar corresponding to the second viewing device 22. When positions and directions of the virtual camera and the other virtual camera are determined so that the second viewing device 22 and the third viewing device 23 observe the free viewpoint video in the same direction at positions adjacent to each other, the avatars corresponding to the second viewing device 22 and the third viewing device 23 may be displayed so as to be adjacent to each other. Thus, the users of the second viewing device 22 and the third viewing device 23 may share the same video experience while feeling their mutual existence. In the manner described above, the fourth processing ends.

In the video distribution device 10 according to the example embodiment, a position and a direction of another virtual camera corresponding to another user are determined based on a position and a direction of a virtual camera corresponding to a user. Thus, since viewpoints of a plurality of users may be linked to or associated with each other, the plurality of users is allowed to share the same video experience.

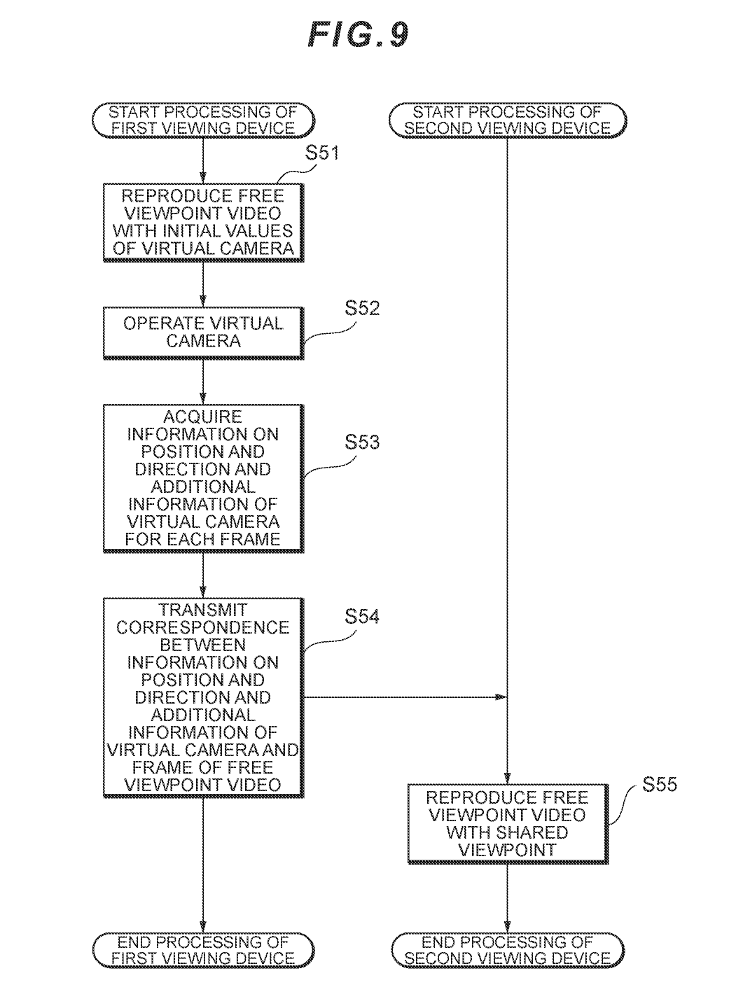

FIG. 9 is a flowchart of fifth processing performed by the video distribution system 1 according to at least one example embodiment. The fifth processing of FIG. 9 is processing in which a viewpoint for observing free viewpoint video is shared between the first viewing device 21 and the second viewing device 22 by, for example, peer-to-peer (P2P). While the foregoing description is made with reference to P2P communication protocols, other protocols may be possible, for example, over the internet, LAN, Wi-Fi, Bluetooth, wireless communication networks, etc.

First, the first viewing device 21 reproduces free viewpoint video with initial values on a position and a direction of a virtual camera (S51). A user uses the first viewing device 21 to operate the virtual camera that observes the free viewpoint video (S52). The first viewing device 21 may receive a change in a position, a direction, a movement direction, a movement speed, movement acceleration, a focal length, a field angle, and a depth of a visual field of the virtual camera. The first viewing device 21 acquires, for each frame of the free viewpoint video, information about a position and a direction of the virtual camera and additional information including a movement direction, a movement speed, movement acceleration, a focal length, a field angle, and a depth of a visual field of the virtual camera, and information about the line of sight of the user (S53). The first viewing device 21 transmits, to the second viewing device 22 by P2P (or other communication protocol), a correspondence between the information about the position and the direction and the additional information of the virtual camera and the frame of the free viewpoint video (S54).

The second viewing device 22 reproduces the free viewpoint video based on the information about the position and the direction and the additional information of the virtual camera and the frame of the free viewpoint video received from the first viewing device 21 (S55). That is, for example, the second viewing device 22 may reproduce the free viewpoint video with a viewpoint shared with the first viewing device 21. In the manner described above, the fifth processing ends. Even if the user of the first viewing device 21 is relatively accustomed to operating a viewpoint of free viewpoint video and the user of the second viewing device 22 is not necessarily accustomed to operating a viewpoint of free viewpoint video, the second viewing device 22 may receive a correspondence between information about a position and a direction of a virtual camera and a frame of a free viewpoint video from the first viewing device 21 used by the user relatively accustomed to operating a viewpoint of free viewpoint video via the video distribution device 10 or may directly receive the same from the first viewing device 21 by P2P (or other communication protocol). Therefore, even the second viewing device 22 used by the user not necessarily accustomed to operating a viewpoint of free viewpoint video may be able to change a viewpoint.

In addition to the foregoing, the operations of the method may be performed in a non-transitory computer readable medium including a processor performing the operations and storage that stores executable instructions to perform the operations.

The example embodiment described above is provided for the purpose of facilitating the understanding of the present inventive concept, and does not intend to limit the interpretation thereof. The respective elements and their arrangements, materials, conditions, shapes, sizes, or the like of the example embodiment are not limited to the illustrated examples but may be appropriately changed. Further, the constituents described in the example embodiment may be partially replaced or combined together.

What is claimed is:

1. A video distribution device comprising:
a reception unit that receives, from a first viewing device, as specified for each frame of a plurality of frames in a free viewpoint video, information related to a position and a direction of a virtual camera that is configured to observe the free viewpoint video that comprises each said frame of the plurality of frames;
a recording unit that records, the information related to the position and the direction of the virtual camera received by the reception unit, together with each said frame of the plurality of frames of the free viewpoint video corresponding to the information related to the position and the direction of the virtual camera; and
a transmission unit that transmits, to a second viewing device, a correspondence between the information related to the position and the direction of the virtual camera and the frame of the free viewpoint video recorded by the recording unit for the information related to the position and the direction of for each said frame of the frames of the free viewpoint video.

2. The video distribution device according to claim 1, wherein
the transmission unit transmits, to the second viewing device, a list including a plurality of correspondences between information related to a plurality of positions and a plurality of directions of the virtual camera and the each frame of the free viewpoint video,
the reception unit receives, from the second viewing device, a correspondence selected from among the plurality of correspondences, and
the transmission unit transmits the selected correspondence to the second viewing device.

3. The video distribution device according to claim 1, wherein the video distribution device is further configured to determine a display position and a display direction of an advertisement based on the information related to the position and the direction of the virtual camera, wherein the transmission unit transmits, to the second viewing device, information for displaying the advertisement at the determined display position and in the determined display direction.

4. The video distribution device according to claim 1, wherein the video distribution device is further configured to determine display positions and display directions of a plurality of avatars based on information related to a plurality of positions and a plurality of directions of the virtual camera, wherein the transmission unit transmits, to the second viewing device, information for displaying the plurality of avatars at the determined display positions and in the determined display directions.

5. The video distribution device according to claim 1, wherein the reception unit receives the information related to the position and the direction of the virtual camera, from the second viewing device.

6. The video distribution device according to claim 5, wherein the transmission unit transmits information for restricting the position and the direction of the virtual camera, to the second viewing device.

7. The video distribution device according to claim 1, wherein:
the reception unit receives, from the first viewing device, information related to at least any one or more of a movement direction, a movement speed, movement acceleration, a focal length, a field angle and a depth of a visual field of the virtual camera, and information related to a line of sight relative to a user of the first viewing device, and
the recording unit records, in correspondence with each other, the each frame of the free viewpoint video, and the information, received by the reception unit, related to at least any one or more of the movement direction, the movement speed, the movement acceleration, the focal length, the field angle and the depth of the visual field of the virtual camera, and the information related to the line of sight relative to the user of the first viewing device.

8. The video distribution device according to claim 1, wherein the recording unit records a range imaged by the virtual camera and the each frame of the free viewpoint video in correspondence with each other.

9. The video distribution device according to claim 1, wherein the video distribution device is configured to determine a position and a direction of another virtual camera so as to maintain a relationship with the position and the direction of the virtual camera, wherein the transmission unit transmits, to the second viewing device, a correspondence between information related to the determined position and the determined direction of the another virtual camera and the each frame of the free viewpoint video.

10. The video distribution device of claim 1, wherein the reception unit comprises a receiving device, the recording unit comprises a recording device, and the transmitting unit comprises a transmitting device.

11. A computer-implemented method of distributing video, comprising:
causing a first viewing device to specify a position and a direction of a virtual camera that is configured to observe free viewpoint video the position and the direction corresponding to each frame of a plurality of frames of the free viewpoint video; and
causing a second viewing device to reproduce the free viewpoint video based on the correspondence between the position and the direction of the virtual camera specified by the first viewing device and each frame of the plurality of frames of the free viewpoint video.

12. The computer-implemented method according to claim 11, further comprising:
transmitting, to the second viewing device, a list including a plurality of correspondences between information related to a plurality of positions and a plurality of directions of the virtual camera and the each frame of the free viewpoint video;
receiving, from the second viewing device, a correspondence selected from among the plurality of correspondences; and
transmitting the selected correspondence to the second viewing device.

13. The computer-implemented method according to claim 11, further comprising determining a display position and a display direction of an advertisement based on the information related to the position and the direction of the virtual camera, and transmitting, to the second viewing device, information for displaying the advertisement at the determined display position and in the determined display direction.

14. The computer-implemented method according to claim 11, wherein display positions and display directions of a plurality of avatars are determined based on information related to a plurality of positions and a plurality of directions of the virtual camera, and information for displaying the plurality of avatars at the determined display positions and in the determined display directions is transmitted to the second viewing device.

15. The computer-implemented method according to claim 11, further comprising receiving the information related to the position and the direction of the virtual camera, from the second viewing device.

16. The computer-implemented method according to claim 11, further comprising:
receiving from the first viewing device, information related to at least any one or more of a movement direction, a movement speed, movement acceleration, a focal length, a field angle and a depth of a visual field of the virtual camera, and information related to a line of sight relative to a user of the first viewing device, and
recording, in correspondence with each other, the each frame of the free viewpoint video, and the information, received by the reception unit, related to at least any one or more of the movement direction, the movement speed, the movement acceleration, the focal length, the field angle and the depth of the visual field of the virtual camera, and the information related to the line of sight relative to the user of the first viewing device.

17. The computer-implemented method according to claim 11, further comprising determining a position and a direction of another virtual camera so as to maintain a relationship with the position and the direction of the virtual camera, and transmitting, to the second viewing device, a correspondence between information related to the determined position and the determined direction of the another virtual camera and the each frame of the free viewpoint video.

18. A non-transitory computer readable medium including instructions to perform distribution of video, the instructions stored in a stage and executed by a processor, the instructions comprising:
receiving, from a first viewing device, information related to a position and a direction of a virtual camera, for each frame of a plurality of frames in a free viewpoint video, that is configured to observe the free viewpoint video;
recording, in correspondence with each other, the information related to the position and the direction of the virtual camera received by the reception unit, and the each frame of the plurality of frames of the free viewpoint video; and
transmitting, to a second viewing device, a correspondence between the information related to the position and the direction of the virtual camera and the each frame of the free viewpoint video recorded by the recording unit.

19. The non-transitory computer readable medium of claim 18, wherein the transmitting transmits, to the second viewing device, a list including a plurality of correspondences between information related to a plurality of positions and a plurality of directions of the virtual camera and the each frame of the free viewpoint video, and the receiving receives, from the second viewing device, a correspondence selected from among the plurality of correspondences, and further wherein the selected correspondence is transmitted to the second viewing device.

20. The non-transitory computer readable medium of claim 18, wherein the instructions further comprise determining a display position and a display direction of an advertisement based on the information related to the position and the direction of the virtual camera, wherein the transmitting transmits, to the second viewing device, information for displaying the advertisement at the determined display position and in the determined display direction.
